(19) United States
(12) Patent Application Publication
(10) Pub. No.: US 2024/0195161 A1
(43) Pub. Date: Jun. 13, 2024

(54) METAL TO METAL ENCAPSULATED OF AN ELECTRICAL POWER CABLE SPLICE INCORPORATING AT LEAST ONE SENSOR

(71) Applicant: Philip HEAD, Berkshire (GB)

(72) Inventor: Philip HEAD, Berkshire (GB)

(21) Appl. No.: 18/553,297

(22) PCT Filed: Mar. 31, 2022
(86) PCT No.: PCT/GB2022/050823

§ 371 Date: Sep. 29, 2023

(30) Foreign Application Priority Data
Mar. 31, 2021 (GB) 2104640.4

(51) Int. Cl. H02G 9/06; H01R 4/02; H01R 13/66; H02G 1/14; H02G 15/013; H02G 15/18

(52) U.S. Cl. CPC H02G 9/06; H01R 4/023; H01R 13/6683; H02G 1/145; H02G 15/013; H02G 15/18

(57) ABSTRACT

A method of sealing a downhole electrical cable providing a chamber around the downhole electrical cable defined by a sleeve or outer body member introducing metal alloy into the chamber melting the metal alloy allowing the molten alloy to set such that the electrical cable is encapsulated by the set molten alloy and sealed from the well environment wherein at least one temperature and/or pressure and/or other sensing probe is included having a connection, the at least one temperature and/or pressure probe and/or the connection at least partly within the chamber.

An Electrical Submersible Pumping (ESP) system is an artificial-lift system that utilizes a downhole pumping system that is electrically driven.

The pump typically comprises several staged centrifugal pump sections that can be specifically configured to suit the production and wellbore characteristics of a given application.

Electrical submersible pump systems are a common artificial-lift method, providing flexibility over a range of sizes and output flow capacities.

A particular weakness of existing systems is that the power cable has to pass through several barriers, which results in a bulkhead and connectors which are either side of the bulkhead.

The barrier could be the wellhead, a downhole packer or the connection to the motor itself commonly called the pot head, it could also include changing from a round cable to a flat cable called a motor lead extension and this is typically spliced together, in a time-consuming method of using different tapes

Inside an oil well, the pressures and temperatures can be very high, in addition, gases are vented and can penetrate the jacket of the power cable and migrate to the connector itself.

Its is also very useful to have the inlet pressure and temperature at the pump, and it is also useful to have the discharge pressure

It is the purpose of the present invention to incorporate at least one sensor into a metal to metal encapsulated cable splice

According to the present invention the cable assemblies are joined by a splice which is encapsulated in a low temperature alloy such as bismuth.

According to a further aspect of the invention, a heater is an external assembly to provide heat in a controlled way to make the bismuth molten, a retrievable temperature probe could precisely record the internal temperature.

According to a further aspect of the invention, a temperature sensor is part of the assembly and is recorded to a data logger

According to a further aspect of the invention, a rubber end fitting seals around the cable at each end of housing.

According to a further aspect of the invention, the ends are cooled so when the low temperature alloy contacts the cooling material it solidifies immediately

According to a further aspect of the invention, the filling system is totally automatic and sealed

According to a further aspect of the invention, the splice can be filled using a funnel and the splice is orientated to an angle from the horizontal

According to a further aspect of the invention the bismuth seals around the cable armour.

According to a further aspect of the invention the bismuth seals around the cable jacket.

According to a further aspect of the invention the bismuth seals around the individual cable conductors.

According to a further aspect of the invention the bismuth can be remelted to enable disassembly.

According to a further aspect of the invention a drain port is provided to enable the bismuth to be emptied from the chamber.

According to a further aspect of the invention the remelted bismuth can be recovered by drain ports.

According to a further aspect of the invention, different melting points of bismuth alloys can be selected depending on the anticipated well bore temperature.

According to a further aspect of the invention the a sensor cable is attached to one phase of the power cable, and this takes power to power the sensor and multiplexes telemetry back onto the cable

According to a further aspect of the invention, two sensors could be incorporated into the splice and one could measure pressure to the pump intake and the second could be in direct contact with the pump discharge pressure.

The term low-temperature-alloy here means any alloy that is solid at the normal temperatures of a wellbore, but is molten at a relatively low temperature, particularly the temperature of common metals and alloys such as copper which is routinely used as a conductor in downhole environments. Although low temperature alloys are strictly a mixture of two different metals or a metal and another element, pure bismuth could be used in any of the examples given.

The following is a more detailed description of an embodiment according to invention by reference to the following drawings in which:

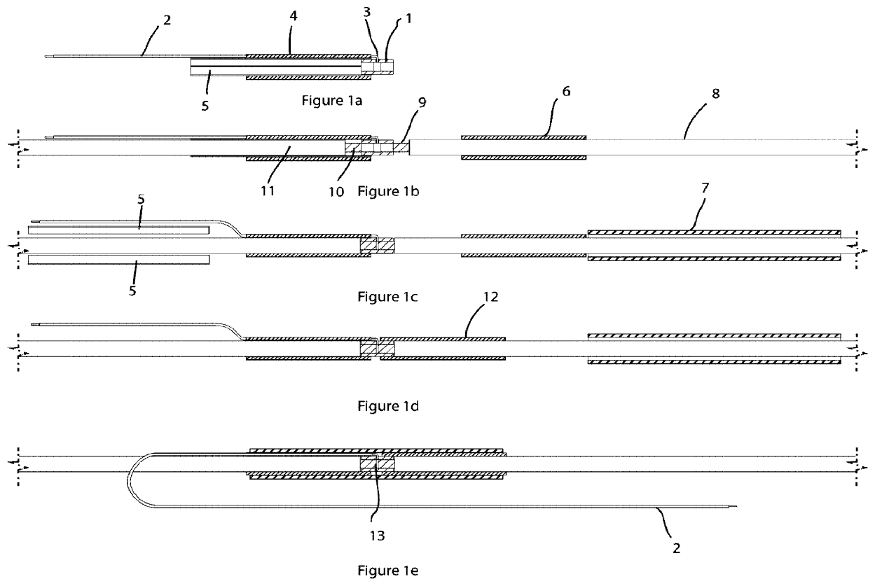

FIG. 1 a,b,c,d,e is the assembly of a splice and an instrumentation as part of the splice.

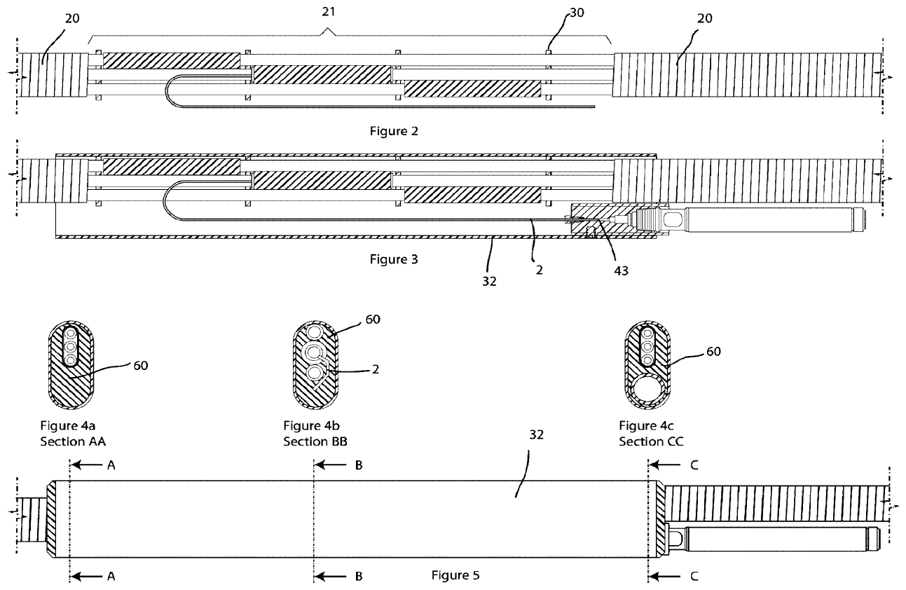

FIG. 2 is a 3-phase cable assembly splice, with the splices staggered, and centralisers fitted and the instrumentation cable loose

FIG. 3 is the assembly in FIG. 2 installed inside a housing and the sensor cable attached to the sensor adaptor

FIG. 4a,b,c are end cross sectional views at section AA,BB,CC of the housing filled with bismuth

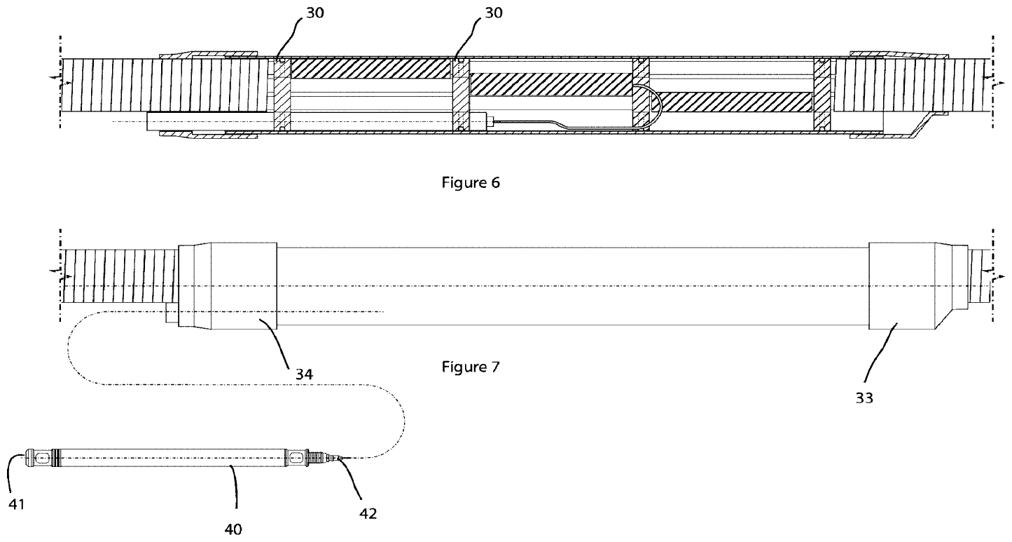

FIG. 5 is an outside view of the splice, with the bismuth visible at each end of the tube and the pressure sensor fully installed into its connector to the sensor cable

FIG. 6 is a section plan view of the splice with a different sensor housing arrangement

FIG. 7 is an outside view of the assemble shown in FIG. 6, with the sensor ready to be installed into its mounting tube, which is fully encapsulated inside the splice

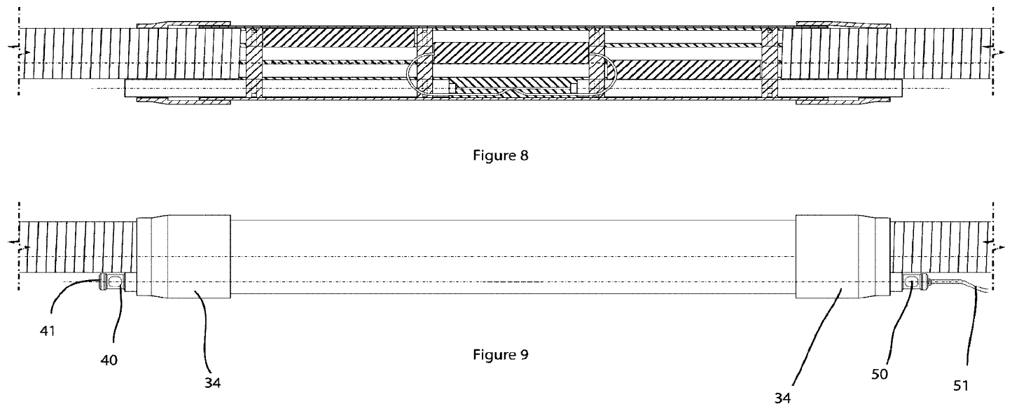

FIG. 8 is a section plan view of the splice with two sensors incorporated into the splice tube.

FIG. 9 is an outside view of the assemble shown in FIG. 8, with the sensors installed in each end of the splice tube.

FIG. 10 is a section end view of the splice tube with a centraliser installed to ensure all the components are correctly spaced, prior to being filled with bismuth.

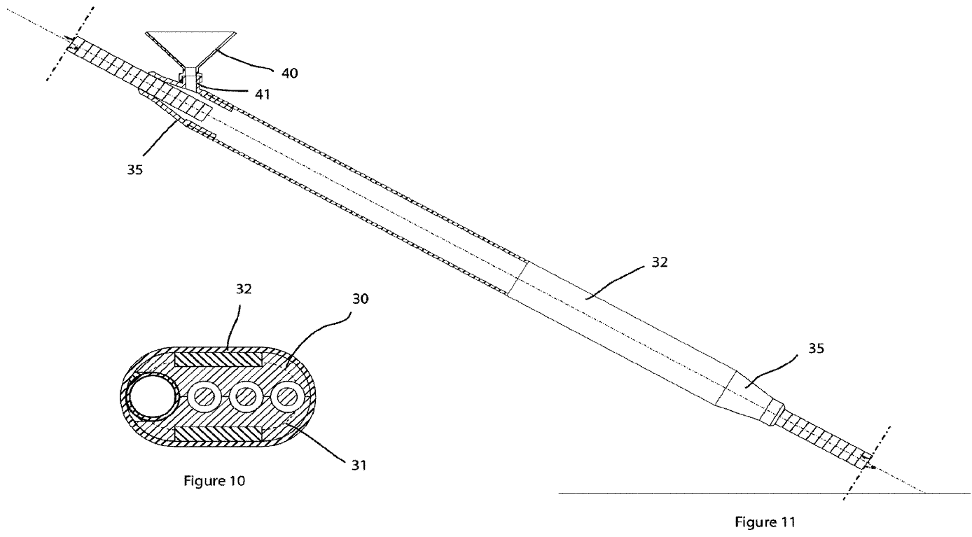

FIG. 11 is the splice tube orientated to 30 degrees from the horizontal and a funnel fitted to fill the tube using gravity.

Referring to FIG. 1 a,b,c,d,e there is shown a sequence of drawings showing how a sensor cable can be incorporated into and electrically insulated splice.

A connector 1 has LH and RH internal thread at each end, and an insulated sensor cable 2 is soldered 3 into the connector 1 at the centre of the connector between the LH and RH internal thread. The sensor cable is embedded in a jacket 4, the jacket is an elastomer, and it is temporarily expanded slightly by a metal sleeve 5.

The two cable ends to be spliced are brought together, and on one side of the splice an outer insulation tube 7 is fitted over the cable jacket 8, then a elastomer jacket 6 is fitted which is identical to 4 without the sensor cable 2. The conductors 9,10 are pushed into contact with the connector 1. Each conductor has a matching RH or LH thread corresponding to the internal threads in the connector one.

The sleeve 5 slides freely over the cable insulation 11. The connector 1 is rotated and like a turn buckle to pull the two cables together until they touch. The steel sleeve 5 can then be removed so the jacket 4 fits snuggly onto the conductor insulation 11.

The connector 1 can be crimped if required, then jacket 6 can be slid into its final position 12, and finally the outer jacket 7 can be slid over jacket 4 and 6 to fully isolate the electrical connection 13

Referring to FIG. 2 to there is shown the assembly process for a field assembled metal to metal encapsulated splice.

The armour 20 is removed a set amount 21 from each end of the cable to be spliced together. Each conductor is cut to a set length so that each splice is offset 82,83,84 from the others.

To ensure the conductors are evenly spaced, a two-piece centraliser 30,31 clips around the conductor, so that they correctly positioned inside the splice tube 32. Referring also to FIGS. 6 and 7, the splice tube is slid over the splice assembly and end caps 33,34 are fitted.

Referring to FIGS. 3 to 5, a sensing assembly 40, contains a pressure transducer 41 in direct contact with the fluid, at the other end is a zero leak high pressure fitting and a conductive temperature probe 42. This connects via the connector 43 to the sensor cable 2 The assembly also includes a signal transmitter, enabling the telemetry to travel to surface utilizing the existing downhole cable as a carrier for the real time data measured by the tool(s)

In FIGS. 8 and 9 two pressure transducers are mounted in the splice tube (enabling intake/discharge and differential pressure, and the second pressure transducer 50 is fitted with a hydraulic tube 51 which has a fitting (not shown) so that it can be tapped into the production tubing and so is in direct contact with the produced fluid, for pressure and flow to be measured

Once the splice and sensor mounting(s) are fitted into the outer housing, and end fittings 33,34, or 35 installed, the entire internal void space is filled with bismuth, or other low temperature alloy, these alloys can melt at 100, 120, 140, 180 C

One method for doing this is shown in FIGS. 10 and 11, which can be applied to both embodiments described. The splice tube is orientated to the horizontal axis to approx. 30 degrees, a funnel 40 is fitted to a fill port 41, the outer housing 32 is heated to about the melting temperature of the low temperature alloy, the alloy is melted on a separate heater, and when molten, poured into the funnel.

When the inside of the tube 32 and end fittings 35 is full, it is quickly cooled and the solidified alloy in the fill port 41 is cut off and dressed back to a smooth finish.

The embodiment shown here is for a three phase electrical cable, but a single conductor cable or other number of phases could be similarly treated.

1. A method of sealing a downhole electrical cable, comprising;
providing a chamber around the downhole electrical cable defined by a sleeve or outer body member;
introducing metal alloy into the chamber;
melting the metal alloy; and
allowing the molten alloy to set;
such that the electrical cable is encapsulated by the set molten alloy and sealed from the well environment;
wherein at least one temperature and/or pressure and/or other sensing probe is included having a connection, the at least one temperature and/or pressure probe and/or the connection at least partly within the chamber.

2. A method according to claim 1, wherein data gathered by the at least one temperature and/or pressure probe is recorded to a data logger.

3. A method according to claim 1, wherein the electrical cable comprises a first electrical cable having an end with a first exposed conductive surface and a second electrical cable having an end with a second exposed conductive surface abutting the first exposed conductive surface of the first electrical cable with the second exposed conductive surface of the second electrical cable so that a conductive path is provided between the first electrical cable and second electrical cable such that the first and second electrical cables are conductively spliced once after the molten alloy has set.

4. A method according to claim 1, wherein the sleeve or outer body member has an inlet for the admission of the metal alloy in a molten state.

5. A method according to claim 1, wherein the electrical cable includes cable armour, and the metal alloy seals around the cable armour.

6. A method according to claim 1, wherein the electrical cable includes a cable jacket, and the metal alloy seals around the cable jacket.

7. A method according to claim 1, wherein heater is an external assembly to provide heat in a controlled way to make the metal alloy molten or retain it in a molten state.

8. A method according to claim 1, wherein metal alloy is remelted to enable disassembly.

9. A method according to claim 1, wherein a drain port is provided to enable the metal alloy to be emptied from the chamber.

10. A method according to claim 9, wherein remelted metal alloy is recovered by drain ports.

11. A method according to claim 1, wherein a particular melting point metal alloy is selected depending on the anticipated well bore temperature.

12. A method according to claim 1, wherein the metal alloy includes bismuth.

13. A method according to claim 1, wherein rubber end fitting seals are provided around the cable at each end of housing.

14. A method according to claim 1, wherein the ends of the sleeve or outer body member are cooled so when the low temperature alloy contacts the cooling material it solidifies immediately.

15. A method according to claim 1, wherein the sealing is carried out automatically.

16. A method according to claim 3, wherein the splice is orientated to oriented at an angle from the horizontal and a funnel is used to introduced the metal alloy.

17. A method according to claim 1, wherein remelted metal alloy is recovered by drain ports.

18. A method according to claim 1, wherein a sensor cable is attached to one phase of the power cable, and this takes power to power the sensor and multiplexes telemetry back onto the cable.

19. A method according to claim 3, wherein two sensors are incorporated into the splice, one sensor measuring pressure to the pump intake and the second sensor in direct contact with the pump discharge pressure.
